(19) United States
(12) Patent Application Publication
(10) Pub. No.: US 2021/0355662 A1
(43) Pub. Date: Nov. 18, 2021

(54) Portable Face Rinsing Faucet Attachment

(71) Applicant: Ian Ott, Marrero, LA (US)

(72) Inventor: Ian Ott, Marrero, LA (US)

(21) Appl. No.: 17/320,851

(22) Filed: May 14, 2021

Related U.S. Application Data
(60) Provisional application No. 63/025,598, filed on May 15, 2020.

(51) Int. Cl. E03C 1/04; B05B 1/06

(52) U.S. Cl. CPC E03C 1/0404; E03C 2001/0417; B05B 1/06

(57) ABSTRACT

In accordance with embodiments of the invention, a portable face rinsing faucet attachment is provided. The portable face rinsing faucet attachment includes a body. An intake channel is operable for attachment to a faucet to receive pressurized water from the faucet. A flow path is defined by the body and is in fluid communication with the intake channel. The flow path is operable to receive pressurized water from the intake channel. A plurality of spray channels is defined by the body and are operable to receive and pressurize water from the flow path. A plurality of spray holes is defined by the spray channels and are operable to receive and spray water from said spray channels. A drain is defined by the body.

### CROSS REFERENCE TO RELATED APPLICATIONS

This application claims priority to U.S. Provisional Patent Application No. 63/025,598, filed May 15, 2020, the entirety of which is incorporated by reference as if fully disclosed herein.

### BACKGROUND OF THE INVENTION

### Field of Invention

The present invention relates generally to attachments for faucets to enable a user to comfortably rinse his or her face.

### General Background

An object of the present invention is to enable consumers with an improved solution to rinse his or her face while reducing or eliminating complexity and water overflow on clothing, counters, and floors. This invention will enable consumers with an easily set up and dismantling option to remove soap, face wash, shaving cream, dirt and debris, as well as any other thinkable items from the face, neck, or head region. Product should be comfortable to the user and positioned at an angle such to prevent back or neck pain.

### SUMMARY OF THE INVENTION

In accordance with embodiments of the invention, a portable face rinsing faucet attachment is provided. The portable face rinsing faucet attachment includes a body. An intake channel is operable for attachment to a faucet to receive pressurized water from the faucet. A flow path is defined by the body and is in fluid communication with the intake channel. The flow path is operable to receive pressurized water from the intake channel. A plurality of spray channels is defined by the body and is operable to receive and pressurize water from the flow path. A plurality of spray holes is defined by the spray channels and is operable to receive and spray water from said spray channels. A drain is defined by the body.

In one embodiment, the intake channel is operable to build fluid pressure within said intake channel.

In one embodiment, the intake channel is conical in shape.

In one embodiment, each spray channel of the plurality of spray channels includes an elongate. A spray channel conduit is defined by the elongate. A spray channel inlet is operable to enable the spray channel conduit to receive water from the flow path. A wall is disposed at the end of the elongate and is operable to create fluid pressure buildup of water flowing into the spray channel conduit.

In one embodiment, at least one spray channel of the plurality of spray channels further includes a second spray channel inlet and a second wall disposed at a second end of said elongate.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts a perspective view of a portable face rinsing faucet attachment in accordance with embodiments of the invention.

FIG. 2 depicts a perspective view of a portable face rinsing faucet attachment in accordance with embodiments of the invention.

FIG. 3 depicts a cross sectional view of a portable face rinsing faucet attachment in illustrating a flow path and spray channel inlets in accordance with embodiments of the invention.

FIG. 4 depicts a cross sectional view of a portable face rinsing faucet attachment in illustrating spray channel conduits in accordance with embodiments of the invention.

FIG. 5 depicts a cross sectional view of a portable face rinsing faucet attachment in illustrating a spray channel conduit with a plurality of walls in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

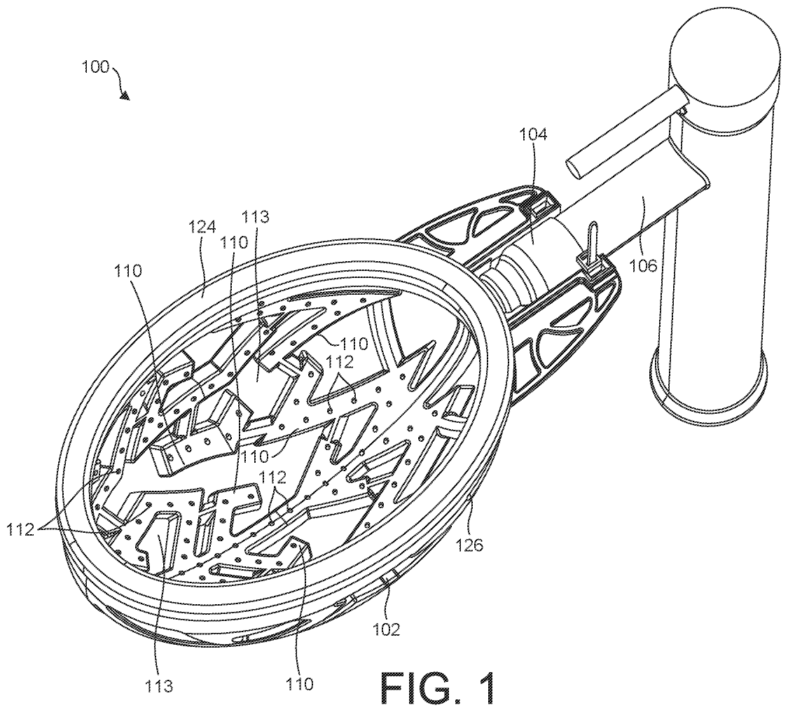

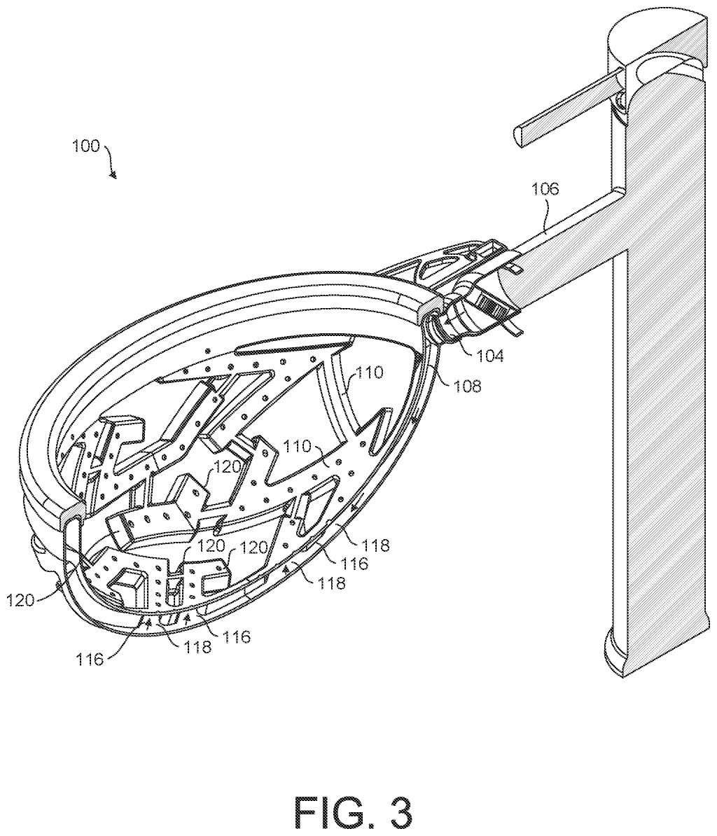

In accordance with embodiments of the invention, a portable face rinsing faucet attachment 100 is provided, as illustrated in FIGS. 1-5. Referring to FIG. 1, the portable face rinsing faucet attachment 100 includes a body 102. The body may be fabricated from a rigid or an elastomeric material, such as plastic or rubber, for example. An intake channel 104 is operable for attachment to a faucet 106 to receive pressurized water from the faucet 106. The intake channel 104 may be secured to the faucet 106 by a clamp or tie wrap, for example. A gasket, such as a rubber gasket, may be disposed within the intake channel 104 to form a seal around the faucet 106 to prevent seepage, for example. As illustrated in FIG. 3, a flow path 108 is defined by the body 102 and is in fluid communication with the intake channel 104. The flow path 108 is operable to receive pressurized water from the intake channel 104. A plurality of spray channels 110 is defined by the body 102 and is operable to receive and pressurize water from the flow path 108. A plurality of spray holes 112 is defined by the spray channels 110 and is operable to receive and spray water from said spray channels 110. A drain 113 is defined by the body 102.

In one embodiment, the intake channel 104 is operable to build fluid pressure within the intake channel 104. The intake channel 104 may include a reducer coupler, as illustrated in the Figures, or be conical in shape, for example. In one embodiment, the intake channel 104 is operable to tilt the device 30-40 degrees relative to the faucet 106.

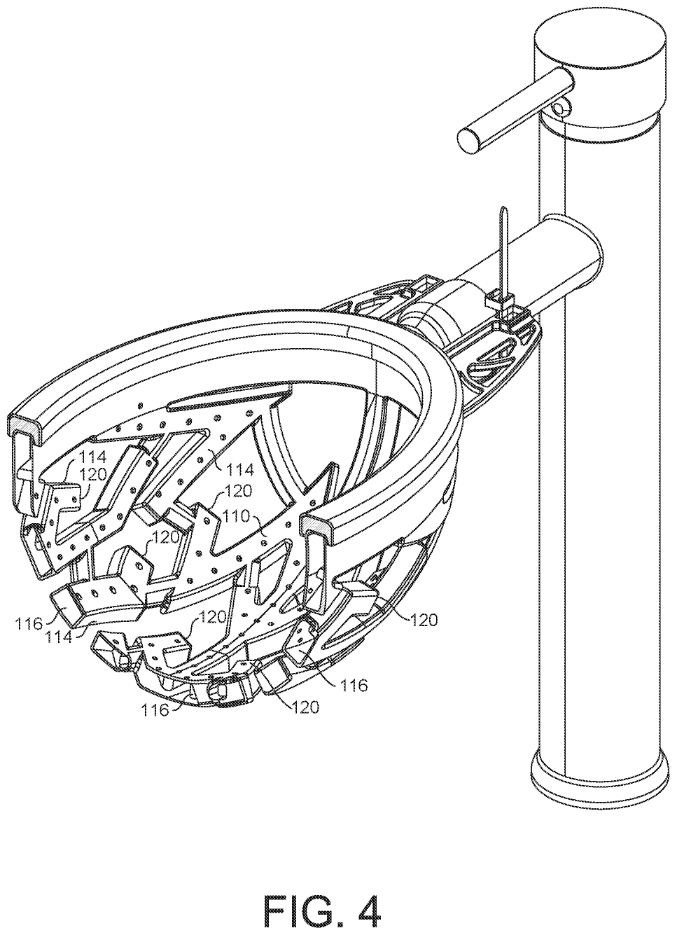

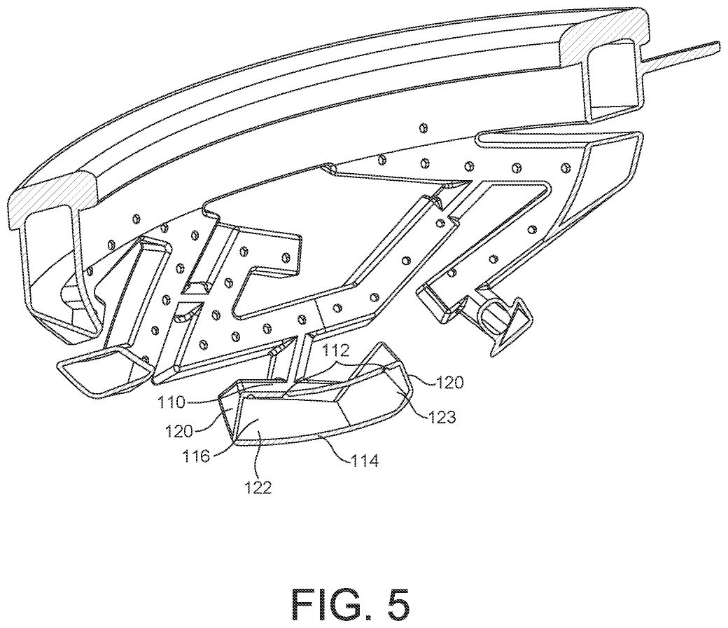

In one embodiment, as illustrated in FIGS. 4-5, each spray channel of the plurality of spray channels 110 includes an elongate 114. A spray channel conduit 116 is defined by the elongate 114. A spray channel inlet 118 is operable to enable the spray channel conduit 116 to receive water from the flow path 108. A wall 120 is disposed at a first end 122 of the elongate 114 and is operable to create fluid pressure buildup of water flowing into the spray channel conduit 116.

In one embodiment, as illustrated in FIG. 5, at least one spray channel of the plurality of spray channels 110 further includes a second spray channel inlet 118 and a second wall 120 disposed at a second end 123 of said elongate 116.

In the embodiment illustrated in the Figures, the portable face rinsing faucet attachment 100 includes a cushion 124 disposed along an outer rim 126 of the body 102. The cushion 124 is operable for a user to rest his or her face while washing their face.

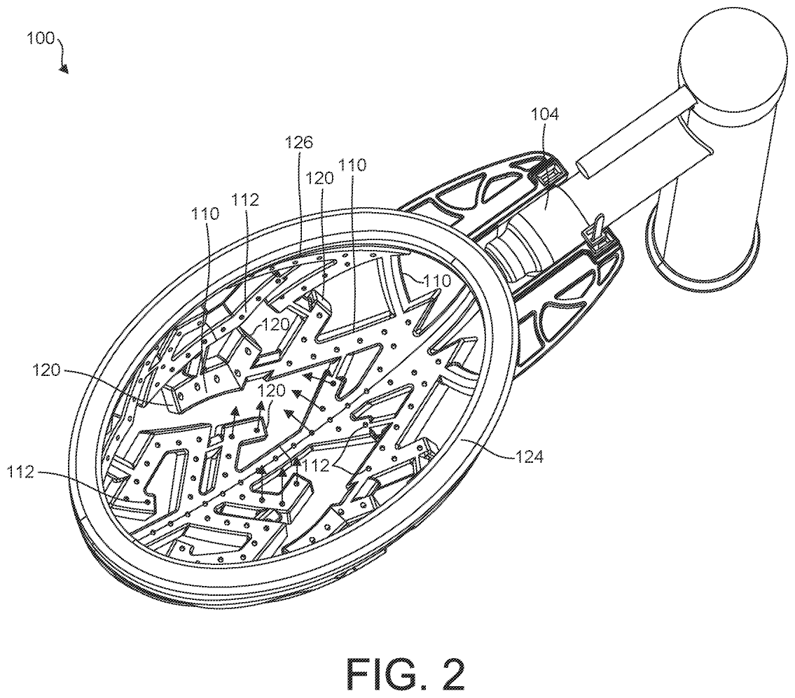

In operation, the portable face rinsing faucet attachment 100 enables an easier way to rinse the face of a person following a soap or chemical wash by eliminating the need to use hands, splashing, or spraying with a hose. In embodiments of the invention, the device is operable to attach to any faucet with a tightening clamp or tie wrap to provide a watertight seal around the faucet 106. As illustrated by the directional arrows in FIGS. 2-3, once the water is turned on, the flow of the water will enter the intake channel 104 and become pressurized because of the decrease in diameter of the intake channel 104. The water will then flow into the flow path 108 and into the spray channels 110 where it the water will build up enough water pressure to spray upward through spray holes 112 to gently rinse the user's face and drain through the drain 113. Water pressure is built in the spray channels 110 as the water enters the spray channel inlet 118 from the flow path 108 and contacts the wall or walls 120. The volume of the spray channel conduit 116 exceeds the volume of water that can be sprayed from the spray holes 112 and thus creates a pressure buildup as water continues to enter the attachment 100 from the faucet 106. The user of the product will place their face on a soft face cushion 124, which may include a gel-like material, for comfort while rinsing face. Once the rinse is completed, the user will turn the water off, dry his or her face, and detach the attachment 100 from the faucet. The attachment 100 can then be stored wherever the consumer chooses to store it until the next use. Alternative applications are in the safety realm as a portable eye wash/face rinse application, for example.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A portable face rinsing faucet attachment, comprising:
a body;
an intake channel, wherein said intake channel operable is for attachment to a faucet, and wherein said intake channel is operable to receive pressurized water from said faucet;
a flow path defined by said body, wherein said flow path is in fluid communication with said intake channel, and wherein said flow path is operable to receive pressurized water from said intake channel;
a spray channel defined by said body, wherein said spray channel is operable to receive and pressurize water from said flow path;
a spray hole defined by said spray channel, wherein said spray hole is operable to receive and spray water from said spray channel; and
a drain defined by said body.

2. The portable face rinsing faucet attachment of claim 1, wherein said intake channel is further operable to build fluid pressure within said intake channel.

3. The portable face rinsing faucet attachment of claim 2, wherein said intake channel is conical in shape.

4. The portable face rinsing faucet attachment of claim 2, wherein said intake channel comprises a reducer coupler.

5. The portable face rinsing faucet attachment of claim 1, further comprising a cushion disposed along an outer rim of said body, said cushion operable for a user to rest his or her face.

6. The portable face rinsing faucet attachment of claim 1, wherein said body is fabricated from an elastomeric material.

7. The portable face rinsing faucet attachment of claim 1, wherein the spray channel comprises:
an elongate;
an interior spray channel conduit defined by said elongate;
a spray channel inlet, said spray channel inlet operable to enable said interior spray channel conduit to receive water from said flow path;
a wall disposed at the end of said elongate, said wall operable to create fluid pressure buildup of water flowing into the interior spray channel.

8. A portable face rinsing faucet attachment, comprising:
a body;
an intake channel, wherein said intake channel operable is for attachment to a faucet, and wherein said intake channel is operable to receive pressurized water from said faucet;
a flow path defined by said body, wherein said flow path is in fluid communication with said intake channel, and wherein said flow path is operable to receive pressurized water from said intake channel;
a plurality of spray channels defined by said body, wherein said spray channels are operable to receive and pressurize water from said flow path;
a plurality of spray holes defined by said spray channels, wherein said spray holes are operable to receive and spray water from said spray channels; and
a drain defined by said body.

9. The portable face rinsing faucet attachment of claim 8, wherein said intake channel is further operable to build fluid pressure within said intake channel.

10. The portable face rinsing faucet attachment of claim 9, wherein said intake channel is conical in shape.

11. The portable face rinsing faucet attachment of claim 9, wherein said intake channel comprises a reducer coupler.

12. The portable face rinsing faucet attachment of claim 8, further comprising a cushion disposed along an outer rim of said body, said cushion operable for a user to rest his or her face.

13. The portable face rinsing faucet attachment of claim 8, wherein said body is fabricated from an elastomeric material.

14. The portable face rinsing faucet attachment of claim 8, wherein each spray channel of said plurality of spray channels comprises:
an elongate;
a spray channel conduit defined by said elongate;
a spray channel inlet, said spray channel inlet operable to enable said spray channel conduit to receive water from said flow path;
a wall disposed at the end of said elongate, said wall operable to create fluid pressure buildup of water flowing into the spray channel conduit.

15. The portable face rinsing faucet attachment of claim 14, wherein at least one spray channel of said plurality of spray channels further comprises:
a second spray channel inlet; and
a second wall disposed at a second end of said elongate.
